(19) United States
(12) Patent Application Publication
(10) Pub. No.: US 2002/0086703 A1
(43) Pub. Date: Jul. 4, 2002

(54) Mobile computing device docking station

(75) Inventors: Zachary Dimenstein, Bronx, NY (US); Christopher Wright, San Francisco, CA (US)

Correspondence Address: OLIFF & BERRIDGE, PLC, P.O. BOX 19928, ALEXANDRIA, VA, 22320, US

(73) Assignee: BROTHER INTERNATIONAL CORPORATION, Bridgewater, NJ

(21) Appl. No.: 10/026,630

(22) Filed: Dec. 27, 2001

Related U.S. Application Data
(60) Provisional application No. 60/258,374, filed on Dec. 28, 2000.

(51) Int. Cl. H04M 1/00

(52) U.S. Cl. 455/557; 455/573

(57) ABSTRACT

A docking station for a mobile computing device such as, for example, a Palm PC, a personal digital assistant, a cellular phone, or any of a variety of other types of handheld computing devices which have their own LCD displays. The docking station provides a variety of functions to the mobile computing device including: telephone, videophone, fax, digital answering machine, printing, keyboard, modem, internet access digital interface ports for connection to a variety of peripherals including scanners, cameras, disk drives and a number of other peripherals in addition to providing the two typical functions of existing docking stations, i.e., providing power charging to the mobile computing device's rechargeable battery and providing a digital connection between the mobile computing device and a personal computer.

### BACKGROUND OF THE INVENTION

1. Field of Invention

The invention relates to docking stations for Palm PCs, personal digital assistants, cellular phones or other types of mobile computing devices (MCD as they are designated hereafter) which have their own displays.

2. Description of Related Art

Existing docking stations typically provide only two functions: (1) providing power charging to the mobile computer device's rechargeable battery, and (2) providing a digital connection between the mobile computing device and a personal computer (PC). Thus, despite their growing popularity, mobile computing devices are typically used only when the user is away from the office or home as the user derives little benefit from the mobile computing device at home or in the office.

### SUMMARY OF THE INVENTION

The invention addresses the above described issue by converting the mobile computing device into a multi-functional appliance when the mobile computing device is placed in a docking station providing, in addition to the functions provided by existing docking stations, one or more of the following functions: telephone, videophone, fax, digital answering machine, printing, modem and digital interface ports for connection to peripherals, such as scanners, cameras, etc.

The invention is a docking station for a MCD which converts the MCD into a multifunctional appliance allowing users to derive greater benefit from the MCD in their homes and/or offices. When a MCD is docked into the docking station, the combined devices, i.e., the MCD and the docking station, act as a single integrated appliance providing functions such as, for example, the following: (1) the connection of a variety of peripherals such as scanners, printers, disk drives, keyboards, modems, etc.; (2) printing out of information stored on the MCD or received through the docking station to a printer; (3) internet access allowing browsing of the Internet and the sending and receiving of e-mails using the docking station's keyboard and/or the MCD's display and user interface; (4) direct telephone dialing using the MCD's contact database and user interface to automatically dial the phone number of any person in the database.

These and other features and advantages of this invention are described in, or are apparent from, the following detailed description of the embodiments of the systems and methods according to this invention.

### BRIEF DESCRIPTION OF THE DRAWINGS

Various embodiments of the invention will be described in detail, with reference to the following figures, wherein:

FIG. 1 is a block diagram of an exemplary embodiment of the docking station;

FIG. 2 is an exemplary embodiment of a docking station according to the invention, illustrating the attachment of the MCD;

FIG. 3 is an exploded view of FIG. 2;

FIG. 4 is a side view of the exemplary embodiment of FIG. 2 illustrating a MCD in an untilted position;

FIG. 5 is a side view of the exemplary embodiment of FIG. 2 illustrating a MCD in a tilted position;

FIG. 6 is a view of the rear panel of an exemplary embodiment of the docking station illustrating a variety of connectors;

FIG. 7 is a block diagram of a second exemplary embodiment of the invention.

FIG. 8 is a block diagram of a third exemplary embodiment of the invention; and

FIG. 9 is a view of a rear panel of the third exemplary embodiment of the invention.

### DETAILED DESCRIPTION OF EXEMPLARY EMBODIMENTS

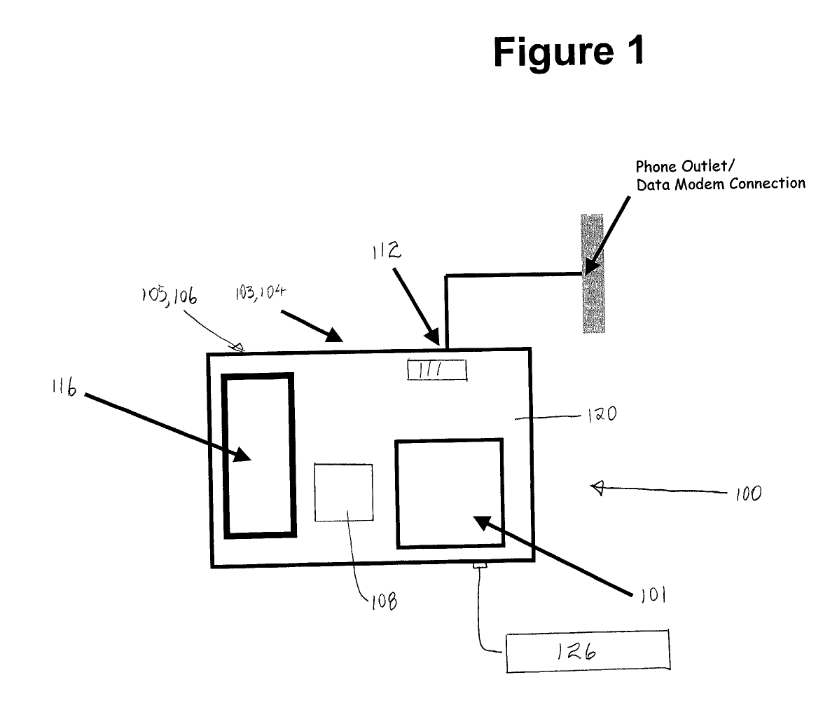

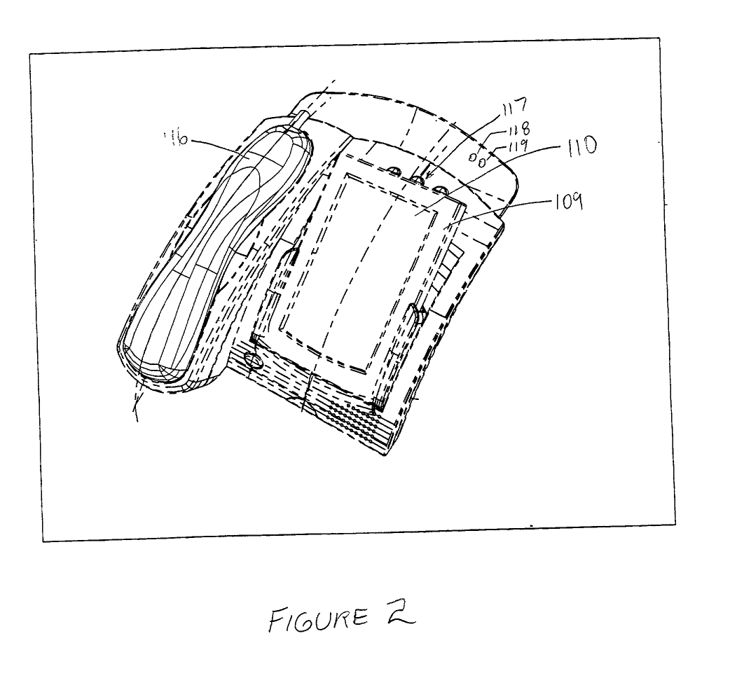

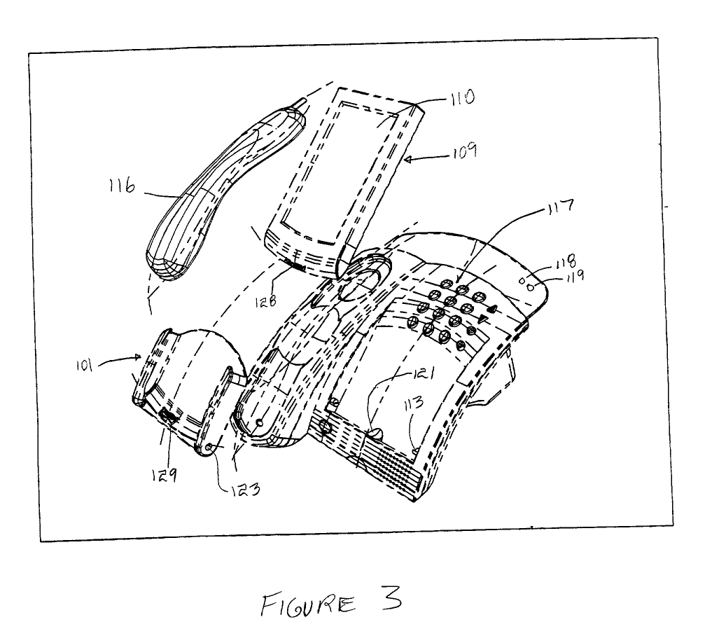

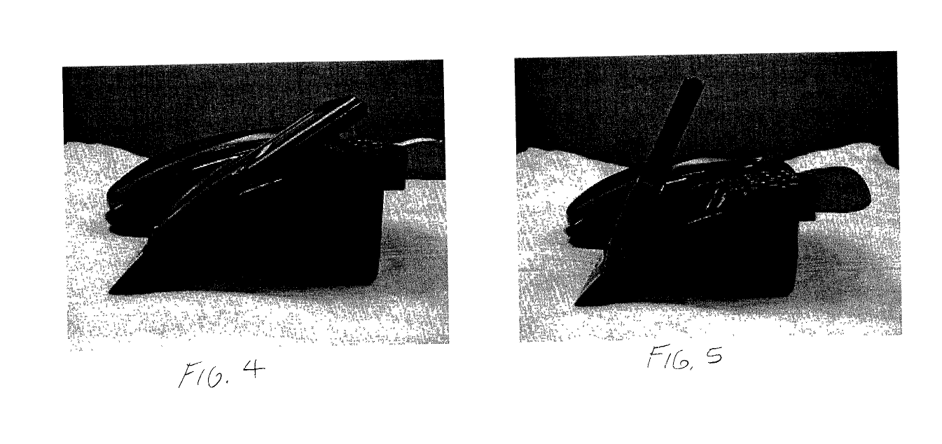

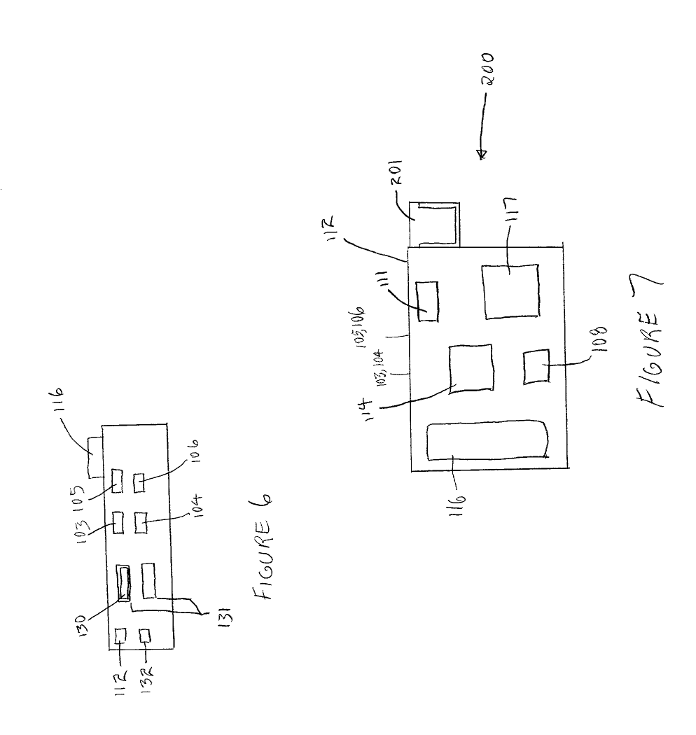

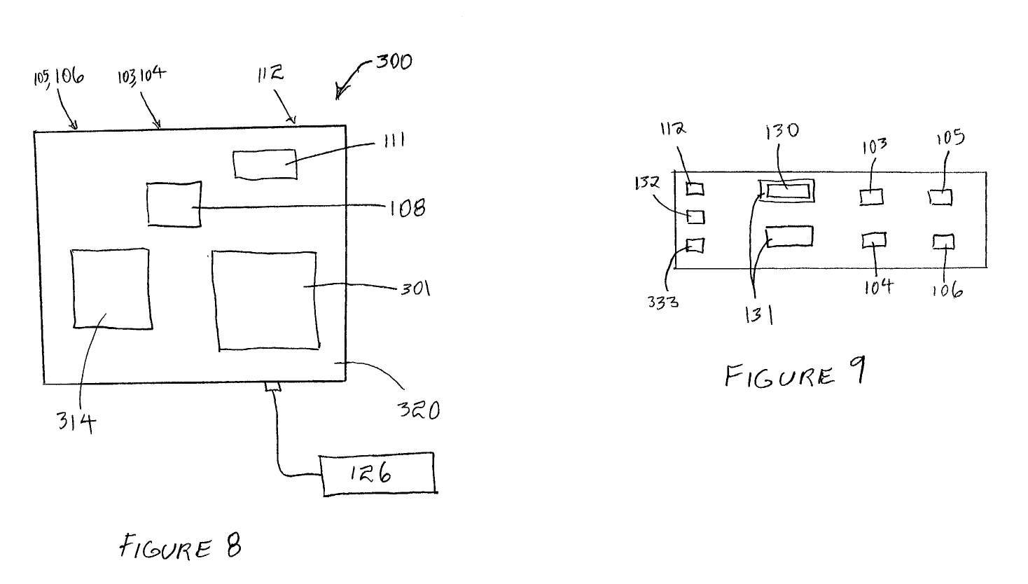

FIG. 1 illustrates one exemplary embodiment of a docking station 100 having a base 120, a MCD holder 101, a phone 116, a phone and/or a fax data modem connector 112, a modem port 132 and peripheral connectors 103-106. The MCD holder 101, as illustrated in FIGS. 1-3, 4, 5 and 7 may be detachable and is pivotal to optimize the viewing angle (FIG. 5). Because there are a number of MCD 109 (FIG. 2) on the market having different shapes and electrical connectors, each MCD 109 may require a different MCD holder 101 to accommodate the shape and the electrical connections for a particular MCD 109. However, all MCD holders 101, regardless of the MCD 109 accommodated, are configured to physically and electrically connect to the docking station as illustrated in FIGS. 2 and 3.

Once the MCD 109 is connected to the MCD holder 101 and the MCD holder 101 is physically and electrically connected to the base 120 of the docking station 100, the MCD 109 can, through appropriate software, interface with the phone 116, the modem 102 and any peripherals connected to peripheral connectors 103, 104, 105, 106. Peripherals connected may include keyboards, scanners, printers, cameras, etc. Further, connectors 103, 104, 105, 106 may be USB, infrared or any of the various other connector types available.

Docking station software must be installed onto the MCD 109 prior to initial use of the invention. Installation of the software may be done by the manufacturer, by the user through a personal computer or by a variety of other means known in the art. When the software is installed via a personal computer, the user installs an executable file on a personal computer from a compact disc. Alternatively, the user may install the executable file, via a PC, from a floppy disk, the Internet, or any of a variety of other means known in the art. The user then runs the software and uploads it to the MCD 109 via a dedicated PC docking station or a variety of other means known in the art. The software may automatically install onto the MCD 109 upon running.

The docking station software may be customized for the individual user upon initial use of the docking station 100. If the user has his/her own Internet service provider, then he/she is able to enter this information either during the initial installation of the software via the PC or during use of the software on the MCD 109 via the keyboard or keypad 117 of the docking station 100, the touch sensitive LCD 110 of the MCD 109 or other user interfaces of the MCD 109 known in the art. If the user does not have his/her own Internet service provider, the docking station software on the MCD 109 can automatically set up an Internet service account for the user based on the geographic location of the user.

The user can also select custom information channels through the software on the MCD 109 using the keyboard or keypad 117 of the docking station 100 or the touch sensitive LCD 110 of the MCD 109. The user can provide his/her geographic location in order to access geographic specific information, such as weather, movies, TV guides and traffic information. This and other types of information will automatically be downloaded to the MCD 109 whenever it accesses the Internet through the docking station 100.

The docking station software is uniquely configured to take advantage of the features provided by the docking station 100. The software is automatically activated whenever the MCD 109 is connected to the docking station 100.

The software within MCD 109 is able to differentiate between the docking station of the invention and any other docking station as the software causes the MCD 109 to look for a unique identifying signal sent by the docking station 100 whenever a mobile computing device is connected. Thus, the software is launched whenever the MCD 109 is docked in the docking station 100 of the invention.

When the software is activated, the main page is displayed on the LCD display 110 of the MCD 109. This main page provides icons for the primary functions of the docking station 100, i.e., check e-mail, browse the Internet, access content channels, direct phone dial, change personal options, print, scan, etc. When the user presses one of these icons, the corresponding application is activated. When the icons for check e-mail and browse the Internet are pressed, e-mail or Web browsing software on the mobile computing device is activated, respectively. Custom selected channels are also accessed through the Web browsing software. The user can choose to have the MCD 109 automatically dial into the Internet and access e-mails and custom selected channels every time the mobile computing device is inserted into the docking station.

The docking station 100 includes the phone 116 that is operable regardless of whether the MCD 109 is inserted. The phone 116 is integral to the docking station 100 and may be cordless or with a cord. When the MCD 109 is not docked, the user simply uses the phone buttons 117 on the docking station 100 or those on the phone 116 if wireless. When the MCD 109 is docked, the user may use, in addition to the phone buttons 117 or the buttons on the phone 116, the touch sensitive buttons provided through an LCD display 110 of the MCD 109, or through direct dialing where the user may press the name of a specific person on the LCD display 110 of the MCD 109 and the docking station 100 to automatically dial the number of that person.

The docking station 100 may also have an integrated digital answering machine 114 that is functional regardless of the presence of the MCD 109. When the MCD 109 is docked, information such as, for example, caller ID, may be displayed on the LCD display 110 of the MCD 109. In addition, digital voice files may be transferred to the MCD 109 for later access.

When the MCD 109 is docked in the docking station 100, the docking station software may direct the contiguous saving of incoming phone messages on the MCD 109 and the integrated digital answering machine 114. Additionally, the docking station software may direct the MCD 109 to communicate with the integrated digital answering machine 114 and to store all phone messages currently residing on the integrated digital answering machine 114 on the MCD 109 if they are not currently stored on the MCD 109. If the MCD 109 lacks sufficient memory to store all messages, the docking station software directs the MCD 109 to display an out of memory message on the LCD display 110 and to store only as many complete messages as the memory of the MCD 109 will allow. Naturally, all messages, including those stored on the MCD 109, continue to reside in the integrated digital answering machine 114 until the user deletes them via the keypad 117, keyboard 126 or MCD 109.

Internet connectivity is enabled by integrating a modem 111 into the docking station 100 and a modem port 112 that connects the modem 111 to a phone outlet. However, integration of the modem is unnecessary as an external modem may provide connectivity to the internet through one of ports 103, 104, 105, 106 or through the phone and/or fax data modem connector 102. The digital circuitry and appropriate software drivers within the MCD 109 use the modem 111 to access the Internet. Alternatively, the modem 111 could be a high band width modem or the docking station 100 may connect to a high band width modem through a USB, ethernet or other port (not shown). If the MCD 109 has wireless capability, the docking station 100 can simply use the wireless capability of the MCD 109 to access the Internet.

When the MCD 109 is connected to the docking station 100, data stored on or received by the MCD 109 or docking station 100 may be printed on a printer 108 integral with the docking station or connected to the docking station 100 via peripheral connections 103, 104, 105, 106. The printer 108 may be of various types including sheet fed and thermal roll types. The printer 108, if internal to the docking station 100 would be sufficient to print data such as: a daily task list, contact information, movie and TV guides, weather and stock information, etc. However, printers connected via peripherals 13, 14, 15, 16 may be standard printers.

A keyboard 126, in addition to the telephone keypad 117 on the base 120 may be included with the docking station 100 to facilitate the quick and easy entry of information into the MCD 109. The keyboard 126 is configured as a pull-out keyboard and/or as a wireless keyboard. If a pull-out keyboard 126, it is preferably hidden beneath the docking station when not in use and pulled out when a keyboard 126 is required. A wireless keyboard requires the docking station to have either an infrared or wireless transceiver and could be stowed in virtually any location. If the keyboard 126 is not included with the docking station 100, information may be entered into the MCD 109 via the keypad 117 or via the MCD 109 user interface.

The electrical interface of the docking station 100 is formed by at least one hinge pin 113, which, in turn, is connected to the main part of the docking station 100. This arrangement enables the electrical interface, i.e., the at least one hinge pin 113, of the docking station 100 to rotate. Thus, when the MCD holder 101 is connected to the electrical interface 113 of the docking station 100, i.e., the MCD holder 101 is connected to the at least one hinge pin 113, the MCD holder 101 is able to rotate to enable the user to optimize the viewing angle. The at least one hinge pin 113 provides friction to enable the user to touch the screen of the MCD 109 without moving it and to, with sufficient force, change the tilt angle of the MCD holder 101 when desired. Alternatively, detents, and a number of other methods and devices known in the art, may be used to change and hold tilt angles of the MCD holder 101.

The docking station 100 is uniquely designed to accommodate several different MCD 109. This is accomplished by supporting interchangeable MCD holders 101, each of which is configured to support the form factor and electrical interface of specific types of MCD 109. Regardless of the form factor of the MCD 109, the outer shape of the connector fits snugly into a slot within the main body of the docking station 100, while the inner shape of the connector is designed to match that of a specific MCD 109. A latch (not shown) to lock the MCD holder 101 in place on the docking station 100 could be used but is not required. The electrical interface of the MCD holder 101 has an outside portion 123 connecting to the electrical interface , i.e., the at least one hinge pin 113, of the docking station 100 and an inside portion 129 connecting to the unique electrical interface of the MCD 109.

The docking station 100 is capable of indicating whether the electrical connection between the MCD 109 and the docking station 100 is proper. This may be accomplished through the use of first LED 118 on the docking station 100, a signal via the display of the MCD 109, a sound, or other means suitable for bringing the condition of the electrical connection to the attention of the user.

The docking station 100 is capable of charging the battery of the MCD 109 via the electrical connection provided by the MCD holder 101 and the at least one hinge pin 113. The docking station 100 is also capable of detecting whether the battery of the MCD 109 is charging or fully charged. The docking station 100 may indicate that the battery of the MCD 109 is charging by illuminating the first LED 118 and indicate that it is fully charged by illuminating a second LED 119 of a different color than the first LED 118.

The docking station software is automatically activated whenever the MCD 109 is connected to the docking station 100 and enables the MCD 109 to use any peripheral attached to the peripheral connectors 103, 104, 105, 106. Possible peripherals include, but are in no way limited to, scanners, cameras, plotters, magnetic disk drives, printers, compact disc drives, DVD drives, and tape drives. Thus, the docking station 100 also provides the MCD 109 with access to a variety of peripherals.

Drivers for the peripherals must be run from the MCD 109 as each type of MCD 109 tends to have a different operating system. Drivers may be stored on the MCD 109 during a software installation via a PC to reside in the memory of the MCD or provided to the MCD 109 by the docking station 100 via flash cards 130 connected to universal flash card connector ports 131. Drivers provided via flash cards 130 add flexibility with respect to the number and kinds of peripherals and may be uploaded to the MCD 109 at the time of docking and reside on the MCD 109 only during the time the MCD 109 is docked in the docking station 100. Such a feature would compensate for the limited memory of some MCD 109.

FIG. 5 depicts another embodiment of the invention in which a detachable MCD holder 201 is attached to a sidewall of the docking station 200. This embodiment gives the user the advantage of full view and unfettered use of the phone keypad 117 of the docking station 100 without the necessity of tilting the MCD 109 and the MCD holder 201 when the MCD 109 is docked. The MCD holder 201 of this embodiment may be integral to the docking station 100 or detachable.

While the invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

FIG. 8 is a block diagram of a third exemplary embodiment having a base 320, a MCD holder 301, a phone and/or fax data modem connector 112 for connecting the docking station 300 to a telephone jack, e.g., a wall mounted phone outlet, and a phone connector 333, as shown in FIG. 9, for connecting the docking station 300 to a telephone inlet, i.e., connecting to a telephone. In this embodiment, the base includes a modem for internet access but does not include a telephone. This embodiment gives the user the advantage of using an existing telephone or a new telephone of his/her own choosing as the telephone is not integral to the docking station 300. The docking station 300 is simply placed or spliced into the communication line between a wall outlet and a receiver and/or speaker on the telephone, i.e., a handset. The user may then dial a number using the MCD 109, in which case the docking station 300 dials a number from the database of the MCD 109 then acts as a conduit from the wall outlet to a receiver or speaker, e.g., a handset of the telephone.

The docking station 300, when used in conjunction with a telephone provides all the advantages/capabilities of the first and second embodiments excepting an integrated telephone. When the docking station 300 is not used in conjunction with a telephone, it provides the user all the advantages/capabilities of the first and second embodiments excepting telephone features.

The docking station 300 may include an integrated digital answering machine 314. However, this embodiment requires the user to choose between using an answering machine provided with the telephone and using integrated digital answering machine 314 as the answering machine of the telephone could interfere with the digital answering machine 314 and vice versa.

What is claimed is:

1. A docking station for a mobile computing device, comprising:
a base;
a holder for physically and electrically connecting the mobile computing device to the base; and
a telephone, the telephone being capable of directly dialing a number stored in a database on the mobile computing device when the mobile computing device is connected to the docking station, the telephone being capable of dialing a number through operation of the telephone keypad when the mobile computing device is not docked.

2. The docking station of claim 1, further comprising a hinge pin, the hinge pin forming an electrical interface to the base, wherein the holder is physically and electrically connected to the hinge pin, the hinge pin allowing the holder to rotate about an axis of the hinge pin.

3. The docking station of claim 1, wherein the holder is a detachable holder.

4. The docking station of claim 3, wherein the detachable holder is interchangeable with at least one other detachable holder for at least one other mobile computing device of a different form or type.

5. The docking station of claim 4, wherein the detachable holder and the at least one other detachable holder includes an outside portion and an inside portion, the outside portion providing an electrical connection to an electrical interface of the docking station, the inside portion providing an electrical connection to a unique electrical interface of the mobile computing device and the at least one other mobile computing device, respectively.

6. The docking station of claim 1, further comprising a printer for printing data stored on at least one of the mobile computing device and the docking station.

7. The docking station of claim 1, further comprising a digital answering machine, the digital answering machine being capable of functioning as a standalone answering machine when the mobile computing device is not docked in the docking station, the digital answering machine being capable of storing messages on the mobile computing device when the mobile computing device is docked in the docking station.

8. The docking station of claim 1, further comprising at least one peripheral connector for electrically connecting at least one peripheral device to the docking station, the at least one peripheral connector allowing communication between the mobile computing device and the at least one peripheral device.

9. The docking station of claim 1, further comprising a data modem, the data modem enabling the mobile computing device to access the Internet.

10. The docking station of claim 1, further comprising a fax modem, the fax modem enabling the mobile computing device to fax data to a receiver over a public switched telephone network.

11. The docking station of claim 1, further comprising a keyboard for quick and easy entry of data to the mobile computing device.

12. The docking station of claim 11, wherein the keyboard interfaces with the docking station via an infrared transceiver.

13. The docking station of claim 11, wherein the keyboard is wireless, the keyboard interfacing with the docking station via electromagnetic waves.

14. The docking station of claim 9, wherein the data modem is a high bandwidth data modem.

15. The docking station of claim 8, further comprising at least one flash card connector for at least one flash card, the flash card containing a driver for the at least one peripheral, the driver being suitable for a particular mobile computing device, wherein docking station software allows the mobile computing device to store the driver in the memory of the mobile computing device to communicate with the at least one peripheral while the mobile computing device is docked in the docking station.

16. The docking station of claim 15, wherein the docking station software allows the mobile computing device to automatically delete the at least one driver from the memory of the mobile computing device when the mobile computing device is disconnected from the docking station.

17. The docking station of claim 1, wherein docking station software is automatically activated whenever the mobile computing device is docked in the docking station.

18. The docking station of claim 17, wherein the docking station sends a unique identifying signal to the mobile computing device when the mobile computing device is docked in the docking station and, wherein the docking station software enables the mobile computing device to recognize the docking station by detecting and recognizing the unique identifying signal.

19. The docking station of claim 8, wherein the at least one peripheral device is a printer and, wherein data stored or received by the mobile computing device or the docking station may be printed on the printer.

20. The docking station of claim 1, further comprising a printer, wherein data stored or received by the mobile computing device or the docking station may be printed on the printer.

21. A docking station for a mobile computing device, the mobile computing device having a rechargeable battery, comprising:
a base;
a holder for docking the mobile computing device in the docking station, the holder providing an electrical connection between the mobile computing device and the docking station;
a charger for recharging the rechargeable battery; and
a telephone, the telephone being capable of directly dialing a number stored in a database on the mobile computing device when the mobile computing device is connected to the docking station, the telephone being capable of dialing a number through operation of the telephone keypad when the mobile computing device is not docked.

22. The docking station of claim 21, wherein the holder is electrically connected to a hinge pin, the hinge pin allowing the holder to rotate about an axis of the hinge pin, the hinge pin forming an electrical interface to the docking station.

23. The docking station of claim 21, wherein the holder is a detachable holder.

24. The docking station of claim 23, wherein the detachable holder is interchangeable with at least one other detachable holder for at least one other mobile computing device of a different form or type.

25. The docking station of claim 24, wherein the detachable holder and the at least one other detachable holder includes an outside portion and an inside portion, the outside portion providing an electrical connection to an electrical interface of the docking station, the inside portion providing an electrical connection to a unique electrical interface of the mobile computing device and the at least one other mobile computing device, respectively.

26. The docking station of claim 21, further comprising a printer for printing data stored on the mobile computing device.

27. The docking station of claim 21, further comprising a digital answering machine, the digital answering machine being capable of functioning as a standalone answering machine when the mobile computing device is not docked in the docking station, the digital answering machine being capable of storing messages on the mobile computing device when the mobile computing device is docked in the docking station.

28. The docking station of claim 21, further comprising at least one peripheral connector for electrically connecting at least one peripheral device to the docking station, the at least one peripheral connector allowing communication between the mobile computing device and the at least one peripheral device for control of the at least one peripheral device and for data exchange between the peripheral device and the mobile computing device.

29. The docking station of claim 21, further comprising a data modem, the data modem enabling the mobile computing device to access the Internet.

30. The docking station of claim 21, further comprising a fax modem, the fax modem enabling the mobile computing device to fax data to a receiver over a public switched telephone network.

31. The docking station of claim 21, further comprising a keyboard for quick and easy entry of data to the mobile computing device.

32. The docking station of claim 31, wherein the keyboard interfaces with the docking station via an infrared transceiver.

33. The docking station of claim 31, wherein the keyboard is wireless, the keyboard interfacing with the docking station via electromagnetic waves.

34. The docking station of claim 29, wherein the data modem is a high bandwidth data modem.

35. The docking station of claim 28, further comprising at least one flash card connector for at least one flash card, the flash card containing a driver for the at least one peripheral, the driver being suitable for a particular mobile computing device, wherein docking station software allows the mobile computing device to store the driver in the memory of the mobile computing device to communicate with the at least one peripheral while the mobile computing device is docked in the docking station.

36. The docking station of claim 35, wherein the docking station software allows the mobile computing device to automatically delete the at least one driver from the memory of the mobile computing device when the mobile computing device is disconnected from the docking station.

37. The docking station of claim 21, wherein docking station software is automatically activated whenever the mobile computing device is docked in the docking station.

38. The docking station of claim 37, wherein the docking station sends a unique identifying signal to the mobile computing device when the mobile computing device is docked in the docking station and, wherein the docking station software enables the mobile computing device to recognize the docking station by detecting and recognizing the unique identifying signal.

39. The docking station of claim 28, wherein the at least one peripheral device is a printer and, wherein data stored or received by the mobile computing device or the docking station may be printed on the printer.

40. The docking station of claim 21, further comprising a printer, wherein data stored or received by the mobile computing device or the docking station may be printed on the printer.

41. A docking station for a mobile computing device, the mobile computing device having a rechargeable battery, comprising:
a base;
a holder for docking the mobile computing device in the docking station, the holder providing an electrical connection between the mobile computing device and the docking station;
a charger for recharging the rechargeable battery;
a telephone, the telephone being capable of directly dialing a number stored in a database on the mobile computing device when the mobile computing device is connected to the docking station, the telephone being capable of dialing a number through operation of the telephone keypad when the mobile computing device is not docked;
a digital answering machine, the digital answering machine being capable of functioning as a standalone answering machine when the mobile computing device is not docked in the docking station, the digital answering machine being capable of storing messages on the mobile computing device when the mobile computing device is docked in the docking station;
a printer; and
a modem, wherein the base, the holder, the charger, the telephone, the printer and the modem are integral to the docking station.

42. The docking station of claim 41, wherein the detachable holder is electrically connected to a hinge pin, the hinge pin allowing the holder to rotate about an axis of the hinge pin, the hinge pin forming an electrical interface to the docking station.

43. The docking station of claim 41, wherein the holder is a detachable holder.

44. The docking station of claim 43, wherein the detachable holder is interchangeable with at least one other detachable holder for at least one other mobile computing device of one of a different form and type.

45. The docking station of claim 44, wherein the detachable holder and the at least one other detachable holder includes an outside portion and an inside portion, the outside portion providing an electrical connection to an electrical interface of the docking station, the inside portion providing an electrical connection to a unique electrical interface of the mobile computing device and the at least one other mobile computing device, respectively.

46. The docking station of claim 41, wherein the printer is for printing data stored on mobile computing device or the docking station.

47. The docking station of claim 41, further comprising at least one peripheral connector for electrically connecting at least one peripheral device to the docking station, the at least one peripheral connector allowing communication between the mobile computing device and the at least one peripheral device.

48. The docking station of claim 41, wherein the data modem enables the mobile computing device to access the Internet.

49. The docking station of claim 41, wherein the modem enables the mobile computing device to fax data to a receiver over a public switched telephone network.

50. The docking station of claim 41, further comprising a keyboard for quick and easy entry of data to the mobile computing device.

51. The docking station of claim 41, wherein the keyboard interfaces with the docking station via an infrared transceiver.

52. The docking station of claim 41, wherein the keyboard is wireless, the keyboard interfacing with the docking station via electromagnetic waves.

53. The docking station of claim 48, wherein the data modem is a high bandwidth data modem.

54. The docking station of claim 47, further comprising at least one flash card connector for at least one flash card, the flash card containing a driver for the at least one peripheral, the driver being suitable for a particular mobile computing device, wherein docking station software allows the mobile computing device to store the driver in the memory of the mobile computing device to communicate with the at least one peripheral while the mobile computing device is docked in the docking station.

55. The docking station of claim 54, wherein the docking station software allows the mobile computing device to automatically delete the at least one driver from the memory of the mobile computing device when the mobile computing device is disconnected from the docking station.

56. The docking station of claim 41, wherein docking station software is automatically activated whenever the mobile computing device is docked in the docking station.

57. The docking station of claim 56, wherein the docking station sends a unique identifying signal to the mobile computing device when the mobile computing device is docked in the docking station and, wherein the docking station software enables the mobile computing device to recognize the docking station by detecting and recognizing the unique identifying signal.

58. The docking station of claim 47, wherein the at least one peripheral device is a printer and, wherein data stored or received by the mobile computing device or the docking station may be printed on the printer.

59. A docking station for a mobile computing device having a rechargeable battery comprising;
a base;
a holder for physically and electrically connecting the mobile computing device to the base;
a charger for recharging the rechargeable battery;
a modem; and
at least one of a phone and a fax data modem connector for connecting the docking station to a telephone wall outlet.

60. The docking station of claim 59, wherein the holder is electrically connected to a hinge pin, the hinge pin allowing the holder to rotate about an axis of the hinge pin, the hinge pin forming an electrical interface to the docking station.

61. The docking station of claim 49, wherein the holder is a detachable holder.

52. The docking station of claim 61, wherein the detachable holder is interchangeable with at least one other detachable holder for at least one other mobile computing device of a different form or type.

63. The docking station of claim 62, wherein the detachable holder and the at least one other detachable holder includes an outside portion and an inside portion, the outside portion providing an electrical connection to an electrical interface of the docking station, the inside portion providing an electrical connection to a unique electrical interface of the mobile computing device and the at least one other mobile computing device, respectively.

64. The docking station of claim 59, further comprising a printer for printing data stored on the mobile computing device.

65. The docking station of claim 59, further comprising a digital answering machine, the digital answering machine being capable of functioning as a standalone answering machine when the mobile computing device is not docked in the docking station, the digital answering machine being capable of storing messages on the mobile computing device when the mobile computing device is docked in the docking station.

66. The docking station of claim 59, further comprising at least one peripheral connector for electrically connecting at least one peripheral device to the docking station, the at least one peripheral connector allowing communication between the mobile computing device and the at least one peripheral device for control of the at least one peripheral device and for data exchange between the peripheral device and the mobile computing device.

67. The docking station of claim 59, further comprising a data modem, the wherein the modem is a data modem enabling the mobile computing device to access the Internet.

68. The docking station of claim 59, further comprising a fax modem, the wherein the modem is a fax modem enabling the mobile computing device to fax data to a receiver over a public switched telephone network.

69. The docking station of claim 59, further comprising a keyboard for quick and easy entry of data to the mobile computing device.

70. The docking station of claim 69, wherein the keyboard interfaces with the docking station via an infrared transceiver.

71. The docking station of claim 69, wherein the keyboard is wireless, the keyboard interfacing with the docking station via electromagnetic waves.

72. The docking station of claim 67, wherein the data modem is a high bandwidth data modem.

73. The docking station of claim 66, further comprising at least one flash card connector for at least one flash card, the flash card containing a driver for the at least one peripheral, the driver being suitable for a particular mobile computing device, wherein docking station software allows the mobile computing device to store the driver in the memory of the mobile computing device to communicate with the at least one peripheral while the mobile computing device is docked in the docking station.

74. The docking station of claim 73, wherein the docking station software allows the mobile computing device to automatically delete the at least one driver from the memory of the mobile computing device when the mobile computing device is disconnected from the docking station.

75. The docking station of claim 59, wherein docking station software is automatically activated whenever the mobile computing device is docked in the docking station.

76. The docking station of claim 75, wherein the docking station sends a unique identifying signal to the mobile computing device when the mobile computing device is docked in the docking station and, wherein the docking station software enables the mobile computing device to recognize the docking station by detecting and recognizing the unique identifying signal.

77. The docking station of claim 66, wherein the at least one peripheral device is a printer and, wherein data stored or received by the mobile computing device or the docking station may be printed on the printer.
